(19) United States
(12) Patent Application Publication
(10) Pub. No.: US 2006/0113241 A1
(43) Pub. Date: Jun. 1, 2006

(54) Buoyant filter media

(75) Inventors: James E. Bolton, Toronto (CA); Paul Peterson, Chagrin Falls, OH (US); James C. Stensrud, Grand Rapids, MN (US)

Correspondence Address: WATTS HOFFMANN CO., L.P.A., PO Box 99839, Cleveland, OH, 44199-0839, US

(73) Assignee: Kinetico Incorporated

(21) Appl. No.: 11/247,675

(22) Filed: Oct. 11, 2005

Related U.S. Application Data
(63) Continuation-in-part of application No. PCT/US05/11439, filed on Apr. 4, 2005.
(60) Provisional application No. 60/559,828, filed on Apr. 6, 2004.

(51) Int. Cl. B01D 39/00

(52) U.S. Cl. 210/483; 210/510.1; 210/150; 210/263; 55/490; 55/523

(57) ABSTRACT

Disclosed is buoyant filtration media including a buoyant backbone support and a material disposed in or on the surface of the buoyant backbone support where the filtration characteristics of the filtration media are dependent on the material being disposed in or on the buoyant backbone support. In one embodiment, foamed polypropylene pellets are embedded with ceramic spheroids such that the buoyant media retains its buoyancy yet exhibits the characteristics of ceramic filter media.

### CROSS-REFERENCE TO RELATED APPLICATIONS

The present application is a continuation-in-part application of co-pending PCT application number PCT/US05/011439, filed 4 Apr. 2005, which claims priority of U.S. provisional application Ser. No. 60/559,828, filed Apr. 6, 2004.

### FIELD OF THE INVENTION

The present invention relates generally to the fluid treatment industry, specifically, to buoyant media having a material disposed in or on the surface of the material to obtain desired properties.

### BACKGROUND

Spherical particulates are widely used in the fluid treatment industry to accomplish a wide variety of tasks. For instance, sand is commonly used in a packed state for solids filtration or used in a fluidized or expanded state as support for sessile microorganisms in a biological reactor. Another commonly used particulate, Granular Activated Carbon (GAC), is similarly employed in either a packed or fluidized state. Adsorption processes that occur on GAC are a strong function of its surface area, whereby the larger the surface area the better the adsorption. Therefore, smaller GAC particulates are favored because of the greater surface area per unit volume. Other fluid treatment processes that require similar contact between the liquid and the solid interface, such as ion exchange are likewise well known. Hereinafter the term “particulate” will refer to any solid used in fluid treatment such as but not limited to filter media, biofilm carrier, GAC, and/or ion exchange or other material as know to those of ordinary skill in the art.

In general, these known particulates have a density that is greater than the fluid that they are in contact with and therefore are termed negatively buoyant. Particulates often require fluidization for mixing, mass transfer, cleaning, cracking of GAC, and biofilm cropping on cariers. During these types of actions, heavy particulates require significant energy to overcome gravity. In addition, sinking type particulates confine process flow to a down flow configuration or to a limited up-flow velocity. These trouble areas can be redressed if positively buoyant particulates are employed. It has been attempted to replace traditional particulates with buoyant versions.

For instance, filter media has been developed to replace traditional sinking filter media like sand, anthracite and Filter-Ag. It was recognized that a floating filter media could be used in an up-flow configuration, therefore during the down flow backwash phase both media expansion and solids removal would be facilitated and assisted by gravity. In addition, biological wastewater treatment processes have been developed that rely exclusively on the buoyant nature of plastic spherical biofilm carriers. Another example of buoyant particulate includes the use of plastic spheres floating on hog lagoons to eliminate odors. Sill other buoyant media is apparent to those of ordinary skill in the art.

The problem with buoyant particulates is the limited selection of materials that actually have a specific gravity less than water. Furthermore, common buoyant medias, such as polypropylene, wood and foamed plastics, usually do not have the preferred chemical properties for fluid treatment. For example, particulate polypropylene lacks the surface qualities necessary for adequate solids filtration. In addition, plastic has been shown less effective than materials such as ceramics when used as a biofilm carrier in biological reactors.

### SUMMARY OF THE DISCLOSURE

The present invention is directed to filter media for use in a fluid treatment process. The filter media includes a buoyant backbone support having disposed on or in a particulate material to obtain different fluid treatment properties based on the type of material disposed on or in the surface of the buoyant backbone support. In accordance with the invention, the novel buoyant filtration media utilizes two separate materials. A backbone support provides bulk and buoyancy. In one embodiment, this buoyant backbone provides a substantially spherical support for a second particulate material. Other shaped backbones, such as cubes can also be utilized. The second material is disposed in or on the surface of the buoyant backbone to obtain desired particulate surface properties that optimize the effectiveness of the buoyant backbone material in a fluid treatment process. In a preferred embodiment, the material is embedded in the outer surface of the buoyant backbone support. The selection of the second material is based on the pre-desired properties which will be imparted on the surface of the buoyant filter media when the second material is disposed in or on the surface of the buoyant backbone support.

In one embodiment, the buoyant backbone is foamed plastic polypropylene. Foamed polypropylene, which would not otherwise filter solids effectively from a fluid stream, is embedded with a material that has an affinity for attracting suspended solids. One such particulate material is ceramic. In the case where ceramic is used, the buoyant backbone would then effectively behave like a buoyant ceramic filter media with improved filtration capabilities. The material or combinations of materials disposed in or on the buoyant backbone can facilitate a number of different treatment operations including but not limited to improved bioactivity on bio-film carriers, adsorption, ion exchange and other operations as apparent to those of ordinary skill in the art in view of this disclosure.

Moreover, the material of the present invention improves the surface properties of the buoyant backbone and is selected according to the surface properties desired. Such desired properties include, among others, porosity for solids impaction during filtration and bio-film adherence in fluidized bed bioreactors, electropositive charge to aid in solids attraction during filtration and during bio-film formation as bioreactors ripen, selective molecule attraction during adsorption separation processes, catalytic or enzymatic reactions used to facilitate some chemical change in a fluid, sessil anti-microbial agents used to disinfect a passing stream and other solid-water interface phenomena used in fluid processing.

Buoyant filtration media made according to the present invention is particularly useful in obtaining fluid processing objectives such as in potable water treatment and conditioning, petroleum filtration, cold pasteurization of fruit juices, catalytic reactions in organic solvents and other processes as apparent to those of ordinary skill in the art in view of this disclosure.

The material is disposed in or on the surface of the media by adhering the material to the outer surface of the buoyant media. In a preferred embodiment, the outer surface of polypropylene pellets are embedded with ceramic spheroids by heating the polypropylene pellets at or near their melting point followed by tumbling the plastic pellets with the ceramic for a time period sufficient to embed the ceramic into the outer surface of the polypropylene pellets. In another embodiment, the ceramic may be heated prior to tumbling. Other techniques for adhering the ceramic to the polypropylene pellets are contemplated including the use of solvents, adhesive, and sonic or vibratory melt. Other processes will become apparent to one of ordinary skill in the art in view of this disclosure.

The buoyancy of the backbone can be varied depending on the type of backbone support employed. In one embodiment, the polypropylene pellets are entrained with gas bubbles to alter the buoyancy characteristics of the pellets and in turn the filtration media.

Additional features of the invention will become apparent and a full understanding obtained by reading the following detailed description made in connection with the accompanying drawings.

### BRIEF DESCRIPTION OF DRAWINGS

FIG. 1 is a cross sectional schematic view of buoyant filtration media constructed in accordance with one embodiment of the present invention;

FIG. 2 is a cross sectional schematic view of buoyant filtration media constructed in accordance with another embodiment of the present invention; and

FIG. 3 is a flowchart outlining one method of producing buoyant filtration media according to one embodiment of the present invention.

### DETAILED DESCRIPTION

The present invention is directed to buoyant filtration media having a material disposed in or on the surface of the media for obtaining specific media characteristics for removing particulate matter from a feed liquid passing therethrough. The filtration media comprises polypropylene pellets having a ceramic material embedded in the surface. By embedding the ceramic, buoyant polypropylene media will retain its buoyancy yet have the characteristics of ceramic media. In the illustrated embodiment, coarse, electropositive ceramic is embedded into foamed polypropylene.

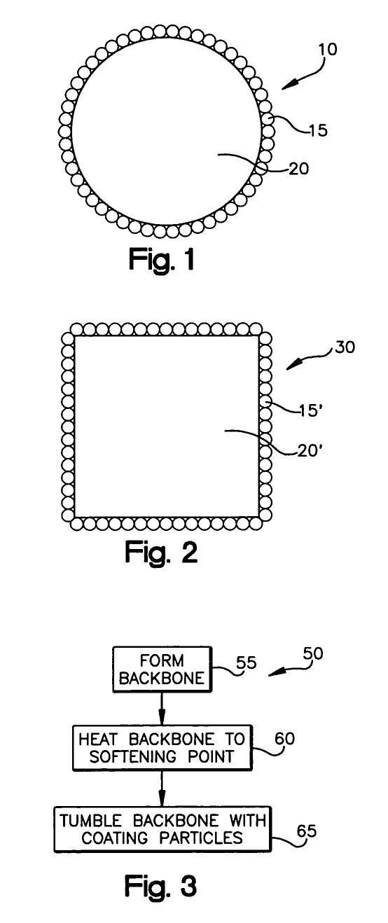

Referring to FIG. 1, in accordance with one illustrated embodiment, buoyant filtration media 10 is formed from a backbone support material comprising raw polypropylene pellets 20 having a preferred diameter of about 5 mm and a preferred density of about 0.92 g/cm³ are embedded at the surface with a ceramic material. Ceramic spheroids 15 with about a 70/80 US-mesh are employed as the embedding material. The ceramic spheroids 15 used in the present invention are those described in U.S. Pat. Nos. 4,632,876, 4,680,230 and 4,725,390 each of which are hereby incorporated by reference in their entirety and are sold under the tradename Macrolite®. Additionally, various other minerals may be employed in place of or in combination with the ceramic. Such minerals can be used at various sizes from about 20 to about 400 US-mesh and would be apparent to one of ordinary skill in the art in view of this disclosure.

One method 50 of constructing filtration media is outlined in the flowchart of FIG. 3. At 55, the backbone of the media is formed. The polypropylene may include varying concentrations of blowing agent, thus producing varying densities. Filter media employing ceramic embedded polypropylene media may comprise polypropylene of entirely one density or a mixture of polypropylene with different densities. The pellets used as the support media are constructed from extruded polypropylene that is cut into beads of various sizes and shapes. (An example of cube shaped buoyant filtration media 30 that includes a cube shaped polypropylene core 20 is shown in FIG. 2) Prior to extrusion, blowing agent may be injected into the polypropylene to create a foam which can create pellets having varying densities. The foamed polypropylene pellets are then embedded with a ceramic material in or on the surface.

The process of embedding the ceramic in or on the outer surface of the polypropylene is accomplished by tumbling polypropylene pellets 65 (FIG. 3) with ceramic spheroids to a point in which the spheroids are embedded in the outer surface of the polypropylene pellets. The polypropylene pellets are first heated (60, FIG. 3) to a point in which the outer surface of the pellet becomes tacky to the touch. Usually, this point is at or near the melting point of the polypropylene. Further, the ceramic spheroids are heated prior to the embedding process. It has been found by the inventors that by heating the spheroids prior to embedding, the spheroids tend to embed further into the surface of the polypropylene pellets.

The heated pellets and heated ceramic spheroids are place in a rotary batch kiln for about 2 minutes or for a period of time sufficient to embed the ceramic material in or on the surface of the polypropylene pellets. In the rotary batch kiln, the pellets and ceramic rotate and collide into each other forcing the spheroid to embed in outer surface of the pellet where the spheroids remain mechanically fixed to the plastic surface. Although tumbling in a rotary batch kiln is the preferred method of imbedding the ceramic, other techniques may also be employed. Such techniques include the use of solvents, adhesives, and/or sonic or vibratory melt. Other embedding techniques will be apparent to one of ordinary skill in the art in view of this disclosure.

In cases where improved buoyancy is needed, the plastic support backbone is further entrained with gas bubbles to varying degrees. The density of the embedded foamed polypropylene backbone can range from 0.10 g/cm³ up to the density of the feed liquid. In the case where water is the feed liquid, the upper density of the embedded polypropylene backbone is less than about 1.0 g/cm³.

Many modifications and variations of the invention will be apparent to those skilled in the art in light of the foregoing disclosure. Therefore, it is to be understood that, within the scope of the appended claims, the invention can be practiced otherwise than has been specifically shown and described.

I claim:

1. A filter media for use in a fluid treatment process comprising:
a buoyant support backbone; and
a particulate material disposed in or on the surface of the buoyant support backbone.

2. The media of claim 1 wherein the buoyant support backbone comprises polypropylene.

3. The media of claim 2 wherein the polypropylene is formed into pellets.

4. The media of claim 1 wherein the support backbone comprises foamed polyethylene pellets.

5. The media of claim 4 wherein the support backbone has a density of about 0.92 g/cm³.

6. The media of claim 1 wherein the material comprises ceramic.

7. The media of claim 6 wherein the ceramic has a size not greater than about 70/80 US-mesh.

8. The media of claim 1 wherein the material is embedded in or on the outer surface of the support backbone.

9. The media of claim 1 wherein the buoyancy of the support backbone is dependent on the density of the feed liquid.

10. A filter media for use in a fluid treatment process comprising:
a buoyant polypropylene support backbone; and
a ceramic material embedded in or on the outer surface of the buoyant polypropylene support backbone.

11. The media of claim 10 wherein the polypropylene support backbone is formed into pellets.

13. The media of claim 10 wherein the support backbone comprises foamed polyethylene pellets.

13. The media of claim 12 wherein the support backbone has a density of about 0.92 g/cm³.

14. The media of claim 10 wherein the material comprises ceramic.

15. The media of claim 14 wherein the ceramic has a size not greater than about 70/80 US-mesh.

16. The media of claim 10 wherein the material is embedded in or on the outer surface of the support backbone.

17. A method of making a filter media for use in a fluid treatment process, defined by the steps comprising:
heating a buoyant support backbone to its melting point;
heating a material to be embedded in the outer surface of the support backbone; and
mixing the support backbone in the presence of the material for sufficient time such that the material embeds in or on the outer surface of the support backbone.

18. A filter media for use in a fluid treatment process comprising:
a buoyant support backbone, and
a material disposed in or on the surface of the support media wherein said material alters the filtering characteristics of the support media.

19. The media of claim 1 wherein the support media is of a smaller diameter than that of the support backbone.

20. The media of claim 10 wherein the support media is of a smaller diameter than that of the support backbone.

21. A method of filtering a feed liquid, said method including the steps comprising:
a. passing the feed liquid over buoyant filter media in a generally up-flow direction, wherein said filter media comprises:
i. a buoyant support backbone; and
ii. a particulate material disposed in or on the surface of the buoyant support backbone.

22. A method of making a filter media for use in a fluid treatment process, defined by the steps comprising:
a. selecting a buoyant support backbone; and
c. attaching a material in or on the outer surface of the support backbone.

23. The method of 22 wherein said backbone is selected from the group consisting of plastics, wood, and foamed ceramic.

24. The method of 23 wherein said plastic is polypropylene.

25. The method of claim 22 wherein said material comprises ceramic spheroids.

26. The method of claim 22 wherein attaching the material to the support backbone includes the steps comprising:
a. heating the buoyant support backbone at or near its melting point;
b. heating a material to be embedded in the outer surface of the support backbone; and
c. mixing the support backbone in the presence of the material for sufficient time such that the material embeds in or on the outer surface of the support backbone.

27. The method of claim 22 wherein attaching the material to the support backbone includes a method selected from the group consisting solvents, adhesive, sonic welding and vibratory welding.

28. The filter media of claim 1 wherein the buoyant support backbone has a cubical shape.

29. The filter media of claim 10 wherein the buoyant support backbone has a cubical shape.

30. The filter media of claim 18 wherein the buoyant support backbone has a cubical shape.
